(19) United States
(12) Patent Application Publication
(10) Pub. No.: US 2004/0099381 A1
(43) Pub. Date: May 27, 2004

(54) Separable curtain structure

(76) Inventor: Henry Lin, Taipei (TW)

Correspondence Address: TROXELL LAW OFFICE PLLC, SUITE 1404, 5205 LEESBURG PIKE, FALLS CHURCH, VA, 22041, US

(21) Appl. No.: 10/301,756

(22) Filed: Nov. 22, 2002

(51) Int. Cl. E06B 3/48

(52) U.S. Cl. 160/84.04

(57) ABSTRACT

The present invention relates to a separable curtain structure, which comprises an upper beam, a curtain cloth, and a self-bonding means. A lanyard-pulling connecting seat is provided in the rear of the curtain cloth for passing the lanyard through therein so that the curtain could be scrolled up or scrolled down through the action of the lanyard. The curtain cloth is bonded with the upper beam by the self-bonding means. A pulling force is applied to the curtain to separate/peel it from the upper beam in order to avoid the occurrence of accident.

### BACKGROUND OF THE INVENTION

(1) Field of the Invention

The present invention relates to a separable curtain structure, in particular to a separable curtain structure comprising an upper beam, a curtain cloth, and a self-bonding means. A lanyard-pulling connecting seat is provided in the rear of the curtain cloth for passing the lanyard through therein so that the curtain could be scrolled up or scrolled down through the action of the lanyard. The curtain cloth is bonded with the upper beam by the self-bonding means. A pulling force is applied to the curtain to separate/peel it from the upper beam in order to avoid the occurrence of accident.

(2) Description of the Prior Art

Nowadays, the purpose of a curtain is to provide sunshade and privacy functions. As shown in FIGS. 1A and 1B, a conventional curtain 10 (Roman type curtain) comprises an upper beam 11 and a curtain cloth 12 which is connected and fixed with a bottom part of the upper beam 11. One end of the upper beam 11 is connected with a lanyard-pulling connecting seat 13. The lanyard-pulling connecting seat 13 is useful for passing a lanyard 14 through therein and a pendent end of the lanyard 14 is outside of the lanyard-pulling connecting seat 13 for being pulled by a user. Plural transverse sections 15 are sewing sutured on the curtain cloth 12 at equal distance. Two holes 16, 16 are provided in the sewing sutured part of the transverse sections 15 for passing the other end of the lanyard 14 through therein and fixing it on the bottom holes 16. Therefore the curtain cloth 12 could be scrolled up or down by pulling or releasing the lanyard 14.

However, a baby bed is always placed near windows and the baby in this stage is active and curious about anything. Therefore a baby for playing will take everything. It is possible that a baby will take the pendent end of the lanyard 14 at the bottom part of the transverse sections 15 to wind around its neck causing death by suffocation. Thus, an improved curtain structure is desired.

### SUMMARY OF THE INVENTION

Under the above circumstances, the present inventors have solved the above disadvantages by the separable curtain structure of the present invention. The separable curtain structure of the present invention comprises an upper beam, a curtain cloth, and a self-bonding means. A lanyard-pulling connecting seat is provided in the rear of the curtain cloth for passing the lanyard through therein so that the curtain could be scrolled up or scrolled down through the action of the lanyard. The curtain cloth is bonded with the upper beam by the self-bonding means. A pulling force is applied to the curtain to separate/peel it from the upper beam in order to avoid the occurrence of accident.

### BRIEF DESCRIPTION OF THE DRAWINGS

For fuller understanding of the nature and objects of the invention, reference should be made to the following detailed description taken in conjunction with the accompanying drawings in which:

FIGS. 1A and 1B show a three-dimension picture of a conventional Roman type curtain.

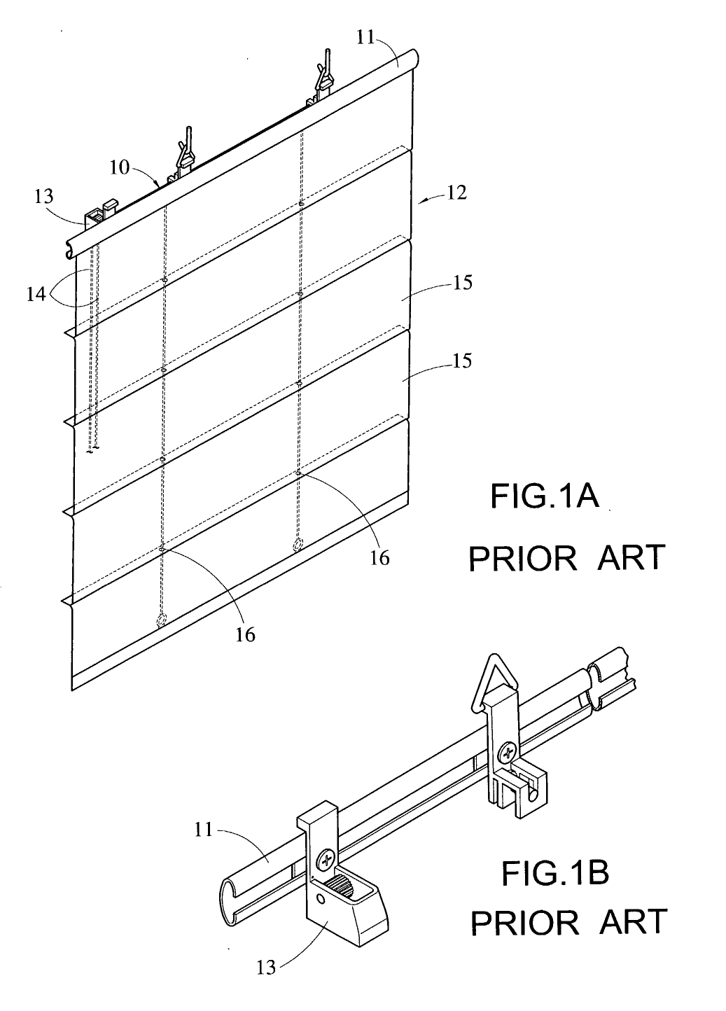

FIG. 2 shows three-dimension picture of the separable curtain structure according to the present invention.

FIG. 3 shows an explosion view of the separable curtain structure according to the present invention.

FIG. 4 shows a rear view of the separable curtain structure according to the present invention.

FIG. 5 shows a schematic view of the separable curtain structure according to the present invention when the curtain is separated from the upper beam by applying a pulling force.

### DETAILED DESCRIPTION OF THE PREFERRED EMBODIMENT

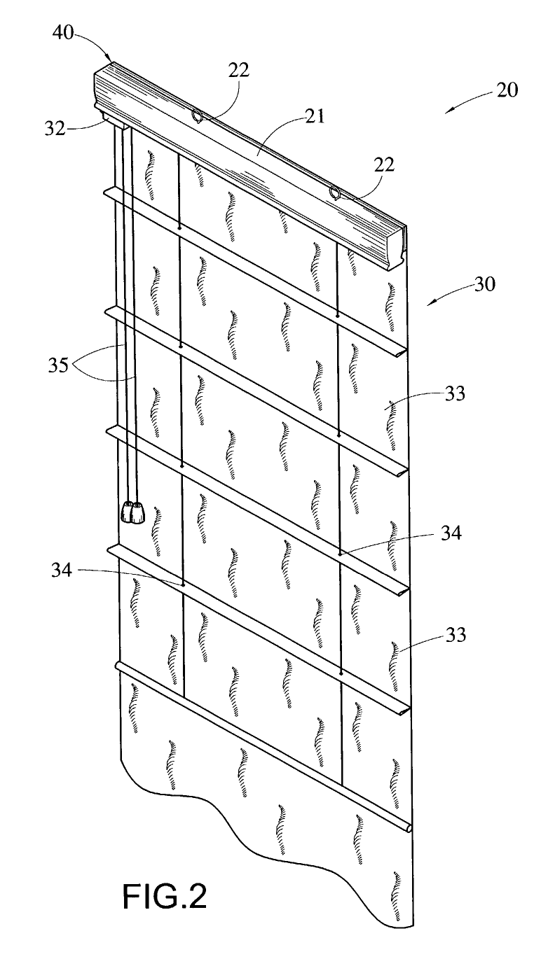

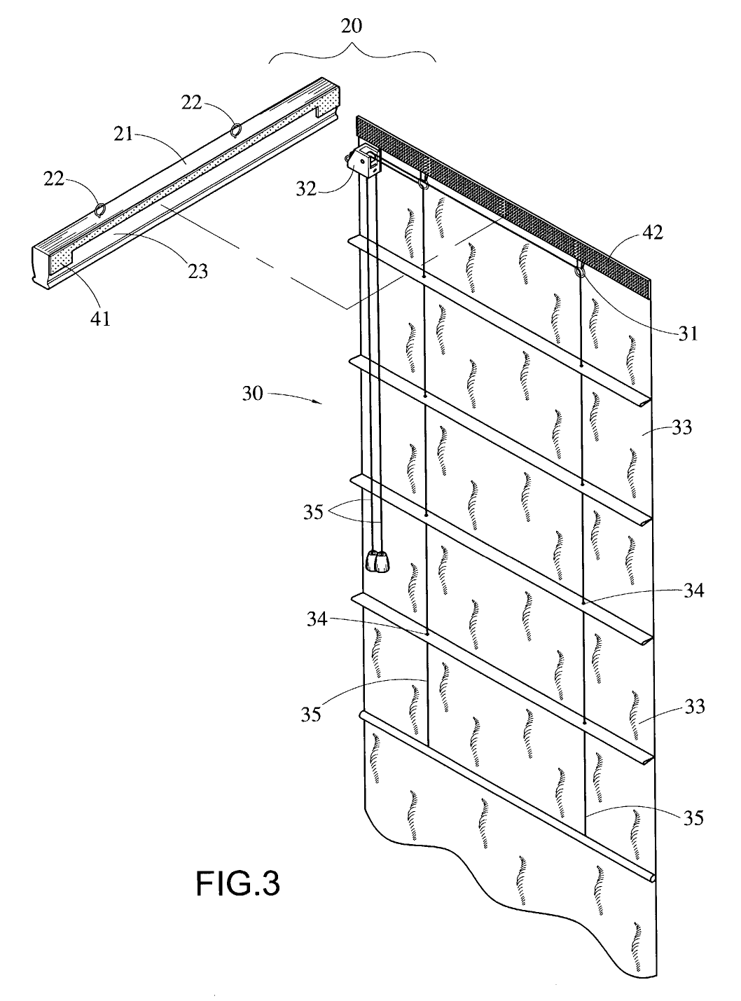

Please refer to FIGS. 2 to 4; the separable curtain structure 20 of the present invention comprises an upper beam 21 on which two hooks 22, 22 are provided so that the upper beam 21 could be hanged on a window frame. Also, a curtain cloth 30 is bonded with the upper beam 21 by using a self-bonding means 40.

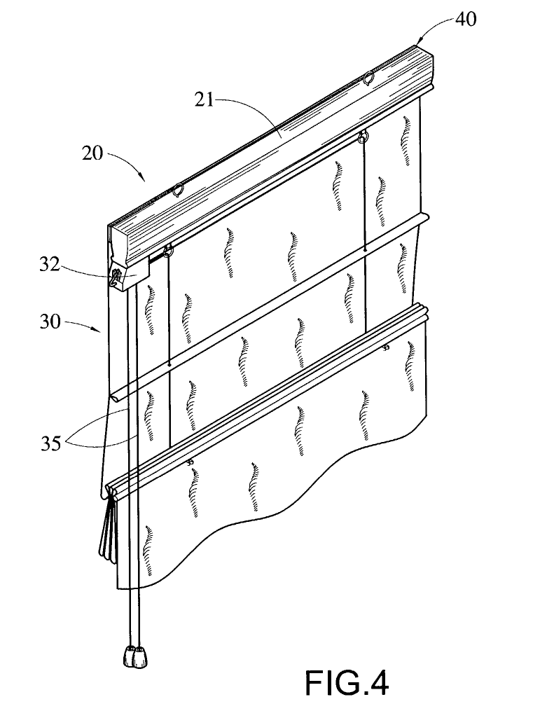

Plural fixing rings 31 are provided on the upper end of the curtain cloth 30 at equal distance and a lanyard-pulling connecting seat 32 is provided on one side of the curtain cloth 30. The curtain cloth 30 is sewing sutured to form plural transverse sections 33. Each transverse section 33 are provided with two holes 34, 34 each for passing one end of a lanyard 35 through therein and fixing on the hole 34 positioned in the bottom part of the transverse sections 33. The other end of the lanyard 35 passes through the fixing rings 31 so that the curtain cloth 30 could be scrolled up or down by pulling or releasing the lanyard 35, as shown in FIG. 4.

It is clearly seen that the lanyard-pulling connecting seat 32, the lanyard 35 and the curtain cloth 30 are bonded together.

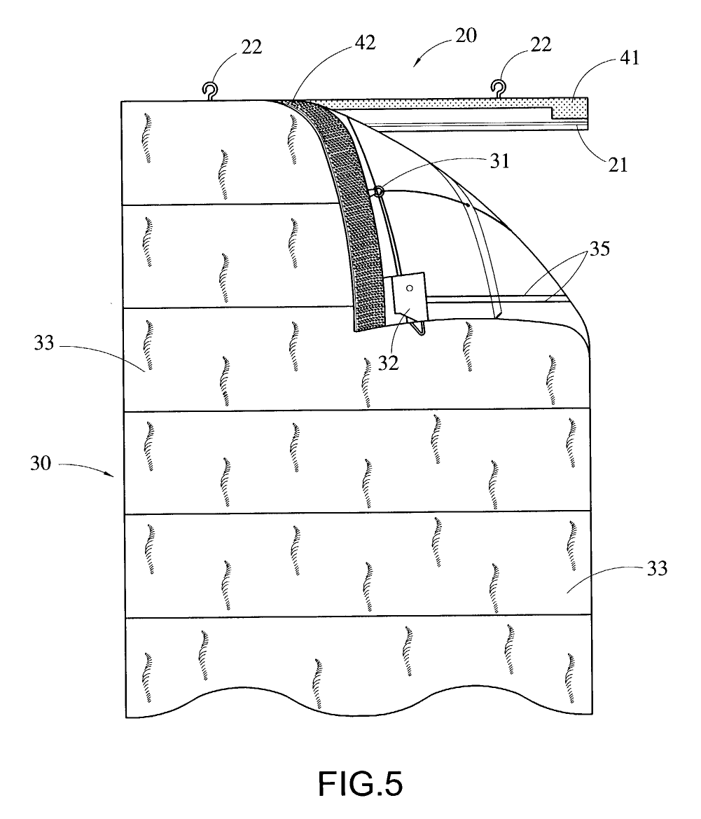

The self-bonding means 40 comprises a hook tape layer 41 and a loop tape layer 42. The hook taper layer 41 is bonded on side 23 of the upper beam 21 and the loop tape layer 42 is bonded on the rear side and upper end of the curtain cloth 30. Therefore, if the loop tape layer 42 is press against the hook tape layer 41, then the curtain cloth 30 is held on the upper beam 21. Further, if a pulling force is applied on either the loop tape layer 42 or the hook tape layer 41, the curtain cloth 30 will separate/peel from the upper beam 21, as shown in FIG. 5.

As such, if one baby or child takes the lanyard 35 carelessly and winds around its neck, the curtain cloth 30 will be separated/peeled from the upper beam 21 by applying force on the self-bonding means 40 to avoid the occurrence of accident.

Although the present invention has been described by the above embodiment, the present invention is not limited by the embodiment. Person skilled in the art would make various changes or modification without departing from the spirit and the scope of the present invention. The present invention is only limited by the appended claims.

What is claimed is:

1. A separable curtain structure, which comprises:
an upper beam having a means for bonding the upper beam with a window frame;
a curtain cloth which is provided with a lanyard-pulling connecting seat at its rear side, lanyard-pulling connecting seat is useful for passing plural lanyards through therein, wherein one end of the lanyard is bonded with a curtain cloth and its other end is pendent on one side of the curtain cloth so that the curtain could be scrolled up or down by pulling or releasing the lanyard; and
a self-bonding means comprising a hook tape layer and a loop tape layer, wherein the hook taper layer is bonded on one side of the upper beam and the loop tape layer is bonded on the rear side and upper end of the curtain cloth,
whereby the curtain cloth is held on the upper beam if the loop tape layer is press against the hook tape layer, and the curtain cloth will separate/peel from the upper beam if a pulling force is applied on either the loop tape layer or the hook tape layer.
